(19) United States
(12) Patent Application Publication
(10) Pub. No.: US 2006/0030634 A1
(43) Pub. Date: Feb. 9, 2006

(54) Radiation curable, sprayable coating compositions

(76) Inventors: Roy E. Dean, Lower Burrell, PA (US); Mildred Lisa Perrine, Allison Park, PA (US); Robert T. Pogue, Pittsburgh, PA (US); Ron Schowengerdt, Waterford, WI (US); David Hagopian, Deerfield, IL (US); Alan Smock, Dubois, IN (US); Inho Song, Chesterand, OH (US)

Correspondence Address: PPG INDUSTRIES, INC.;Law Dept.-Intellectual Property, One PPG Place, Pittsburgh, PA, 15272, US

(21) Appl. No.: 10/910,883

(22) Filed: Aug. 4, 2004

(51) Int. Cl. C09D 11/10

(52) U.S. Cl. 522/103

(57) ABSTRACT

Radiation curable, sprayable compositions are disclosed that include (a) an acrylated epoxy, and (b) at least one multi-functional acrylate monomer. The radiation curable, sprayable compositions of the invention include a material containing an amino group. Also disclosed are multi-layer composite coatings wherein at least one layer is deposited from such compositions.

### CROSS-REFERENCE TO RELATED APPLICATIONS

This application is related to U.S. patent application Ser. No. ______ entitled PRODUCT COMPRISING A THIN-FILM RADIATION-CURED COATING ON A THREE-DIMENSIONAL SUBSTRATE and U.S. patent application Ser. No. ______ entitled PROCESS FOR APPLYING A THIN-FILM RADIATION-CURED COATING ON A THREE-DIMENSIONAL SUBSTRATE, filed concurrently herewith.

### FIELD OF THE INVENTION

The present invention is directed to compositions that are sprayable, radiation curable and, in certain embodiments, substantially free of insert solvents and/or monofunctional reactive diluents, such as monfunctional acrylate monomers. The radiation curable compositions comprise a mixture of an acrylated epoxy and at least one multi-functional acrylate, wherein the radiation curable composition comprises a material containing an amino group. The compositions of the present invention may, for example, be recyclable. The present invention is also directed to multi-layer composite coatings wherein at least one layer is deposited from a composition of the present invention.

### BACKGROUND OF THE INVENTION

Articles containing wood surfaces, such as furniture and cabinets, are often coated with one or more coatings. To provide color to such surfaces, toners and stains containing dyes and/or pigments are often used. Other surface layers, such as sealers and topcoats, may be used alone or in addition to such coloring layers. Typically, a sealer is applied either directly over the wood surface if no coloring layers are present, or, if a toner and/or stain is used, directly over such layers. A topcoat, if used, is typically applied over the sealer layer.

Coating compositions that are radiation curable, essentially solvent-free and/or sprayable are often desired, particularly for wood finish applications. Radiation curable coatings, such as those cured by exposure to ultraviolet (“UV”) radiation, are often preferred for wood finish applications because of the heat sensitivity of wood, which often makes certain thermosetting coatings unfavorable. Acrylated resins are radiation curable and are often used in wood finish coatings.

Coatings that are essentially solvent-free are often desired because solvents, particularly organic solvents, can be costly, hazardous, and environmentally unfriendly. The presence of significant amounts of organic solvents in spray-applied coatings may be particularly undesirable for health and environmental reasons. Coatings that contain water or organic solvents can also be inefficient and costly, because these diluents are typically evaporated from the coating before curing is complete.

Sprayable coatings are often desired as well. Such coatings may be particularly desirable when the article to be coated is irregularly shaped, since it can be difficult to effectively coat such articles by other methods, such as roll-coating. A sprayable coating is a coating that is capable of being applied uniformly by atomization through a device such as a spray gun. Sprayability is a function of the rheology profile, i.e., viscosity, of the coating. Typically, a coating with a viscosity of about 2 to about 300 centipoise at 25° C. (77° F.) is considered to be sprayable. Historically, solvents, such as water or organic solvents, have been required to attain such viscosities in radiation curable wood coatings. More recently, however, reactive diluents, such as relatively low molecular weight acrylate monomers, especially monofunctional acrylate monomers, have been used to achieve sprayability. These diluents react into and become part of the coating. Such essentially solvent-free coating compositions have, however, typically been difficult to apply at relatively low film thickness, such as less than 2.0 mils (50.8 microns) or less than 1.0 mil (25.4 microns).

Several coating compositions that are purportedly radiation curable, solvent-free and/or sprayable have been proposed. For example, U.S. Pat. No. 4,319,811 (“the '811 patent”) describes a coating composition that is alleged to have these attributes. The composition described in the '811 patent is substantially oligomer-free and is obtained by copolymerizing a first monomer that is either a triacrylate or a tetraacrylate with a second monomer having an N-vinyl imido group. The composition may also include a photoinitiator, wetting agents, a surfactant, and other additives.

U.S. Pat. No. 5,453,451 (“the '451 patent”) discloses a coating composition that is also purported to be radiation curable, sprayable, and essentially solvent-free. The compositions described in the '451 patent comprise a polymerizable compound and a photoinitiator. The polymerizable compound is present in an amount ranging from about 80 to about 99.5 percent by weight, based on the total weight of the composition, and comprises a mixture of acrylates, which may include monoacrylates, diacrylates, triacrylates, urethane-modified acrylates, polyester-modified acrylates or a mixture thereof. The photoinitiator is present in an amount ranging from about 0.5 to 15 percent by weight, based on the total weight of the composition, and comprises a free radical or cationic type photoinitiator.

U.S. Pat. No. 6,231,931 (“the '931 patent”) discloses a method of coating a substrate using a substantially 100 percent solids, acrylate-containing UV curable coating composition. The acrylate polymer may be a monoacrylate, diacrylate, triacrylate, urethane-modified acrylate, polyester-modified acrylate, or a mixture thereof. According to the '931 patent, when the composition is to be spray applied to a substrate, the composition should include a mixture of at least one high molecular weight polymer and at least one low molecular weight polymer. The '931 patent also states that, to avoid phase separation during spray application at ambient temperature and pressure, a mixture of 40 percent high molecular weight polymers and 60 percent low molecular weight polymers should be used.

The coatings disclosed in these references do not, however, necessarily address several attributes that have recently become important considerations for radiation curable, solvent-free, sprayable wood finish coatings. One important attribute is recyclability, which relates to the ability to recover and reuse a material. Other important attributes include resistance to yellowing, wetting over various substrates, such as wood, toners, alkyd stains, and sealers, adhesion to alkyd stains, toughness, intercoat adhesion, reduced odor, and appearance. Thus, it would be advantageous to provide coating compositions that are radiation curable, solvent-free, and sprayable and which also exhibit one or more of these attributes.

### SUMMARY OF THE INVENTION

In one respect, the present invention is directed to radiation curable compositions comprising a mixture of: (a) an acrylated epoxy; and (b) at least one multi-functional acrylate, wherein the radiation curable composition comprises a material containing an amino group, and wherein the radiation curable composition is sprayable.

In another respect, the present invention is directed to a wood finish coating composition comprising a mixture of: (a) 10 to 30 percent by weight of an acrylated epoxy; (b) 35 to 65 percent by weight of at least one multi-functional acrylate; (c) 0.01 to 15 percent by weight of a photoinitiator; (d) 10 to 30 percent by weight of an amine modified (meth)acrylate; (e) 0.01 to 5 percent by weight of a rheology modifier; (f) 0.01 to 10 percent by weight of a surfactant; and (g) 0.01 to 10 percent by weight of a UV-light stabilizer, wherein the percents by weight are based on the total weight of the composition, and wherein the wood finish coating composition is sprayable.

In another respect, the present invention is directed to multi-layer composite coatings comprising a sealer deposited from a sealer composition and a topcoat applied over at least a portion of the sealer in which the topcoat is deposited from a topcoat composition, wherein at least one of the sealer composition and the topcoat composition comprises a radiation curable composition comprising a mixture of: (a) an acrylated epoxy; and (b) at least one multi-functional acrylate, wherein the radiation curable composition comprises a material containing an amino group, and wherein the radiation curable composition is sprayable.

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

### BRIEF DESCRIPTION OF THE DRAWINGS

FIG. 1 is a perspective view of a continuous coating apparatus; and

FIG. 2 is a cross-sectional view of the continuous coating apparatus illustrated in FIG. 1.

### DETAILED DESCRIPTION OF EMBODIMENTS OF THE INVENTION

The present invention is directed to compositions, such as coating compositions, which are radiation curable, sprayable and, in certain embodiments, substantially free of insert solvents and/or monofunctional reactive diluents, such as monofunctional acrylate monomers. In certain embodiments, the compositions of the present invention can, for example, be recyclable, have reduced volatiles, and exhibit good resistance to mar, toughness, intercoat adhesion, and/or adhesion to oily surfaces.

The radiation curable, sprayable compositions of the present invention comprise a mixture of: (a) an acrylated epoxy, and (b) at least one multi-functional acrylate and, in certain embodiments, (c) a photoinitiator. The radiation curable compositions of the present invention comprise a material containing an amino group. In certain embodiments of the present invention, the compositions are also substantially free of inert solvents and/or monofunctional reactive diluents, such as monofunctional acrylate monomers.

As used herein, the term “radiation curable” refers to materials having reactive components that are polymerizable by exposure to an energy source, such as an electron beam (EB), UV light, or visible light. In certain embodiments, the compositions of the present invention are polymerizable by exposure to UV light. As used herein, the term “sprayable” refers to compositions that are capable of being applied uniformly by atomization through a device such as a spray gun. Sprayability, as will be appreciated by those skilled in the art, is a function of the viscosity of a material. In certain embodiments, the compositions of the present invention have a viscosity of from 2 to 300 centipoise or, in other embodiments, from 20 to 150 centipoise, or, in yet other embodiments, 20 to 120 centipoise, at high shear at 25° C. (77° F.). The viscosities reported herein may be determined using a Cone and Plate viscometer at 5000 cycles per second as understood by those skilled in the art.

As previously indicated, the compositions of the present invention comprise an acrylated epoxy. As will be appreciated by those skilled in the art, epoxy acrylates are produced through reaction of epoxy resins with (meth)acrylic acids. As used herein, “(meth)acrylic” and terms derived therefrom are intended to include both acrylic and methacrylic. Moreover, in certain embodiments of the present invention, the acrylated epoxy comprises an oligomer having a viscosity at 25° C. (77° F.) of less than 10,000 centipoise, or, in some cases, less than 5,000 centipoise, or, in other cases, about 1,000 centipoise. In certain embodiments of the present invention, the acrylated epoxy comprises an oligomer having a Tg (glass transition temperature) of less than 50° C. (122° F.), or, in some cases, less than 25° C. (77° F.) or, in still other cases, less than 0° C. (32° F.), or, in yet other cases, less than −10° C. (14° F.).

Suitable acrylated epoxies that may be used in the compositions of the present invention include, without limitation, those which are the reaction product of compounds having at least one epoxide group with compounds having per molecule at least one α,β-ethylenically unsaturated double bond and at least one group which is reactive toward epoxide groups. In certain embodiments, the acrylated epoxy may comprise a multi-functional acrylated epoxy. As used herein, the term “multi-functional acrylated epoxy” refers to acrylated epoxies having an acrylate functionality of greater than 1.0.

Some specific examples of commercially available acrylated epoxies that are suitable for use in the compositions of the present invention include, without limitation, EBECRYL 3200, 3201, 3211 and 3212, available from UCB Chemicals. Corporation, Smyrna, Ga.; PHOTOMER 4025, available from Cognis Corp., Cincinnati, Ohio; LAROMER 8765, available from BASF Corp., Charlotte, North; Carolina; and CN115, available from Sartomer Corp., Exton, Pa.

In certain embodiments of the present invention, the composition comprises at least 10 percent by weight of acrylated epoxy or, in some embodiments, at least 15 percent by weight of acrylated epoxy or, in yet other cases, 20 percent by weight up to 80 percent by weight, or, in still other embodiments, from 35 up to 65 percent by weight of acrylated epoxy based on the total weight of the radiation curable composition. In certain embodiments, the composition comprises 10 up to 30 percent by weight of acrylated epoxy based on the total weight of the radiation curable composition. The amount of acrylated epoxy present in the radiation curable compositions can range between any combination of these values inclusive of the recited values.

The compositions of the present invention also comprise at least one multi-functional acrylate. As used herein, the term “multi-functional acrylate” refers to monomers or oligomers having an acrylate functionality of greater than 1.0, such as at least 2.0. Multifunctional acrylates suitable for use in the compositions of the present invention include, for example, those that have a relative molar mass of from 170 to 5000 grams per mole, such as 170 to 1500 grams per mole. In the compositions of the present invention, the multi-functional acrylate may act as a reactive diluent that is radiation curable. Upon exposure to radiation, a radical induced polymerization of the multi-functional acrylate with monomer or oligomer is induced, thereby incorporating the reactive diluent into the coating matrix.

Multi-functional acrylates suitable for use in the radiation curable compositions of the present invention include, without limitation, difunctional, trifunctional, tetrafunctional, pentafunctional, hexafunctional (meth)acrylates and mixtures thereof. As used herein, “(meth)acrylate” and terms derived therefrom are intended to include both acrylates and methacrylates.

Representative examples of suitable multi-functional acrylates include, without limitation, ethylene glycol di(meth)acrylate, 1,3-butylene glycol di(meth)acrylate, 1,4-butanediol diacrylate, 2,3-dimethylpropane 1,3-diacrylate, 1,6-hexanediol di(meth)acrylate, dipropylene glycol diacrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, tripropylene glycol di(meth)acrylate, thiodiethylenglycol diacrylate, trimethylene glycol dimethacrylate, pentaerythritol tri(meth)acrylate, trimethylolpropane tri(meth)acrylate, ditrimethylolpropane tetra(meth)acrylate, glycerolpropoxy tri(meth)acrylate, ethoxylated trimethylolpropane tri(meth)acrylate, and tetraethylene glycol di(meth)acrylate, including mixtures thereof.

In certain embodiments, the radiation curable compositions of the present invention comprise less than 90 percent by weight of multifunctional acrylate or, in some embodiments, less than 85 percent by weight or, in yet other embodiments, more than 20 percent by weight up to less than 80 percent by weight, or, in still other embodiments, from 35 up to 65 percent by weight of multifunctional acrylate based on the total weight of the radiation curable composition. The amount of multifunctional acrylate present in the radiation curable compositions can range between any combination of these values inclusive of the recited values.

In certain embodiments, particularly when the radiation curable composition is to be cured by UV radiation, the compositions of the present invention also comprise a photoinitiator. As will be appreciated by those skilled in the art, a photoinitiator absorbs radiation during cure and transforms it into chemical energy available for the polymerization. Photoinitiators are classified in two major groups based upon a mode of action, either or both of which may be used in the compositions of the present invention. Cleavage-type photoinitiators include acetophenones, α-aminoalkylphenones, benzoin ethers, benzoyl oximes, acylphosphine oxides and bisacylphosphine oxides and mixtures thereof. Abstraction-type photoinitiators include benzophenone, Michler's ketone, thioxanthone, anthraquinone, camphorquinone, fluorone, ketocoumarin and mixtures thereof.

Specific nonlimiting examples of photoinitiators that may be used in the radiation curable compositions of the present invention include benzil, benzoin, benzoin methyl ether, benzoin isobutyl ether benzophenol, acetophenone, benzophenone, 4,4′-dichlorobenzophenone, 4,4′-bis(N,N′-dimethylamino)benzophenone, diethoxyacetophenone, fluorones, e.g., the H-Nu series of initiators available from Spectra Group Ltd., 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, e.g., 2,6-dimethylbenzoyldlphenyl phosphine oxide, 2,4,6-trimethylbenzoyidiphenylphosphine oxide, bis (2,4,6-trimethylbenzoyl) phenyl phophine oxide, 2,6-dichlorobenzoyl-diphenylphosphine oxide, and 2,6-dimethoxybenzoyidiphenylphosphine oxide, bisacylphosphine oxides, e.g., bis(2,6-dimethyoxybenzoyl)-2,4,4-trimethylepentylphosphine oxide, bis(2,6-dimethylbenzoyl)-2,4,4-trimethylpentylphosphine oxide, bis (2,4,6-trimethylbenzoyl)-2,4,4-trimethylpentylphosphine oxide, and bis(2,6-dichlorobenzoyl)-2,4,4-trimethylpentylphosphine oxide, and mixtures thereof.

In certain embodiments, the radiation curable compositions of the present invention comprise 0.01 up to 15 percent by weight of photoinitiator or, in some embodiments, 0.01 up to 10 percent by weight, or, in yet other embodiments, 0.01 up to 5 percent by weight of photoinitator based on the total weight of the radiation curable composition. The amount of photoinitator present in the radiation curable compositions can range between any combination of these values inclusive of the recited values.

The radiation curable compositions of the present invention also comprise a material containing an amino group. In the compositions of the present invention, the amino group may be present as part of the acrylated epoxy, as part of the at least one multi-functional acrylate, or the amino group may be present in a separate component of the radiation curable composition. Though not being bound by any theory, the presence of a material comprising at least one amino group in the compositions of the present invention is thought to affect, for example, the reactivity of the composition, thereby improving the cure response of the composition.

In certain embodiments, the radiation curable compositions of the present invention comprise an amine modified (meth)acrylate. Amine modified (meth)acrylates suitable for use in the present invention are known in the art and include, without limitation, amine modified polyether acrylates, amine modified polyester acrylates, amine modified epoxy acrylates, and amine modified urethane acrylates, including mixtures thereof.

Representative specific examples of commercially available amine modified (meth)acrylates suitable for use in the compositions of the present invention include, without limitation, the LAROMER line of amine-modified acrylates available from BASF Corporation, Charlotte, N.C., such as LAROMER PO77F, PO94F, and LR8996; CN501, CN502, CN550, and CN551 available from Sartomer Corp., Exton, Pa.; and ACTILANE 525, 584, and 587 available from Akcros Chemicals, New Brunswick, N.J.

In certain embodiments, the radiation curable compositions of the present invention comprise at least 5 percent by weight, or, in some cases, at least 10 percent by weight, or, in yet other cases, at least 20 percent by weight of a material containing an amino group based on the total weight of the radiation curable composition. In some embodiments, the radiation curable composition comprises 5 up to 50 percent by weight or, in other cases, 10 up to 30 percent by weight of a material containing an amino group based on the total weight of the radiation curable composition. The amount of the material containing an amino group present in the radiation curable compositions can range between any combination of these values inclusive of the recited values.

In certain embodiments, the compositions of the present invention are substantially free of monofunctional reactive diluents (such as monofunctional acrylate monomers) and/or inert solvents (such as water and inert organic solvents). Indeed, it has been surprisingly found that the particular compositions of the present invention are sprayable, while maintaining desired performance properties, such as resistance to mar, toughness, and intercoat adhesion, even if little or no monofunctional acrylate monomers and/or inert solvents are added. Those skilled in the art will appreciate that such materials are known to be low viscosity materials highly desireable for achieving viscosities suitable for sprayability. As used herein, “substantially free” means that the material is present in the composition, if at all, as an incidental impurity. In other words, the material is not intentionally added to the composition, but may be present at minor or inconsequential levels, because it was carried over as an impurity as part of an intended composition component. In certain embodiments, for example, monofunctional reactive diluents and/or inert solvent are present in the compositions of the present invention in an amount of less than 10 percent by weight or, in some cases, less than 5 percent by weight, and, in yet other embodiments, less than 2 percent by weight based on total weight of the composition. In some embodiments, for example, the compositions of the present invention are free of monofunctional reactive diluents.

At least partly due to the absence of significant amounts of monofunctional reactive diluent and/or inert solvents, it is believed, certain compositions of the present invention exhibit reduced volatility as compared to their radiation curable, sprayable counterparts that include such materials. Indeed, it is believed that monofunctional acrylate monomers not only react into and become part of the coating during cure, but they also evaporate during cure to a greater extent than multi-functional acrylates. This can be an important feature of the present invention, as low volatility results in reduced odor and/or safer handling.

Moreover, in certain embodiments, the radiation curable compositions of the present invention are recyclable. As used herein, the term “recyclable” refers to a composition that remains homogenous after spraying and can be re-sprayed after recirculation while maintaining performance properties, such as resistance to mar, toughness, and intercoat adhesion. For example, in certain embodiments, the radiation curable compositions of the present invention exhibit a weight loss as measured by thermogravimetric analysis (TGA) of less than 10% or, in some cases, less than 7% or, in yet other cases, less than 2%, at 120° F. (49° C.) for 12 hours. The TGA weight losses reported herein were determined in a manner that would be understood by those skilled in the art and are intended to simulate spray and recirculation temperatures for certain spray application conditions.

Moreover, certain embodiments of the present invention exhibit a weight loss of less than 4% or, in some cases, less than 2%, or in yet other cases, less than 1%, as measured by ASTM D5403 Method A, which is specified to simulate potential weight loss of a UV curable coating during UV cure and subsequent finished product aging.

In certain embodiments, the radiation curable compositions of the present invention comprise a rheology modifier. A number of rheology modifiers, either alone or in combination, may be used to produce compositions according to the present invention. For example, suitable rheology modifiers include, without limitation, fumed silicas, organo-clays, modified ureas, nano-aluminum oxide, non-associate thickeners, and mixtures thereof, among others. A suitable rheology modifier that is commercially available and that may be used in the radiation curable compositions of the present invention is a modified lower molecular weight polymeric urea available from BYK-Chemie USA, Wallingford, Conn. sold under the name BYK-410. In certain embodiments, the rheology modifier promotes the recyclability of the radiation curable compositions of the present invention.

In certain embodiments, the radiation curable compositions of the present invention comprise 0.01 up to 5 percent by weight of rheology modifier, in some embodiments, 0.1 up to 2 percent by weight, or, in yet other embodiments, 0.1 up to 1 percent by weight of rheology modifier. The amount of rheology modifier present in the radiation curable compositions can range between any combination of these values inclusive of the recited values.

In certain embodiments, the radiation curable compositions of the present invention comprise one or more suitable surfactants to reduce surface tension. Surfactants include materials otherwise known as wetting agents, anti-foaming agents, emulsifiers, dispersing agents, leveling agents etc. Surfactants can be anionic, cationic and nonionic, and many surfactants of each type are available commercially. Some embodiments of the present invention include at least a wetting agent. Still other radiation curable compositions of the present invention may have additional surfactants to perform additional effects. Some specific wetting agents that may be employed in the radiation curable compositions of the present invention include siloxane-based, Silwet® L-77 wetting agent, available from OSI Specialties, Inc., the BYK®-306 wetting/leveling agent available from BYK Chemie, and the Dow Corning #57 flow control agent available from Dow Corning, among others.

Other suitable surfactants may also be selected. The amount and number of surfactants added to the radiation curable compositions will depend on the particular surfactant(s) selected, but should be limited to the minimum amount of surfactant that is necessary to achieve wetting of the substrate while not compromising the performance of the dried coating. In certain embodiments, the radiation curable compositions of the present invention comprise 0.01 up to 10 percent by weight of surfactant, in some embodiments, 0.05 up to 5 percent by weight, or, in yet other embodiments, 0.1 up to 3 percent by weight of surfactant. The amount of surfactant present in the radiation curable compositions can range between any combination of these values inclusive of the recited values.

In certain embodiments, the radiation curable compositions of the present invention comprise a UV-light stabilizer, such as, for example, a suitable hindered-amine or a UV absorber, such as substituted benzotriazole or triazine. Any of a number of such materials may be used to produce compositions according to the present invention. For example, suitable UV-light stabilizers include a hindered-amine sold under the name TINUVIN 292 and UV absorbers sold under the names TINUVIN 328 and TINUVIN 400, all of which are available from Ciba Specialty Chemicals.

In certain embodiments, the radiation curable compositions of the present invention comprise 0.01 up to 10 percent by weight of UV-light stabilizer and/or UV absorber, in some embodiments, 0.01 up to 5 percent by weight, or, in yet other embodiments, 0.01 up to 2.5 percent by weight of UV-light stabilizer and/or UV absorber. The amount of UV-light stabilizer and/or UV absorber present in the radiation curable compositions can range between any combination of these values inclusive of the recited values.

The radiation curable compositions of the present invention may also include other additives. For example, the radiation curable compositions may contain dyes, pigments, sanding additives, antioxidants, and flatting agents (e.g. wax-coated or non-wax coated silica or other inorganic materials), among other materials.

The radiation curable compositions of the present invention may be applied directly onto the surface of a substrate or over an underlayer by any suitable coating process known to those of ordinary skill in the art, for example, by dip coating, direct roll coating, reverse roll coating, curtain coating, spray coating, brush coating, vacuum coating and combinations thereof. The compositions of the present invention are, however, particularly suitable for application by spray coating. The method and apparatus for applying the coating composition to the substrate may be determined, at least in part, by the configuration and type of substrate material. Dry film thickness for such coatings can range from, for example, about 0.2 to 3.0 mils (5.1 to 76.2 microns) per layer, such as 0.2 to 2.0 mils (5.1 to 50.8 microns) per layer or, in some embodiments, 0.2 to 1.0 mil (5.1 to 25.4 microns) per layer. Indeed, one advantage of the compositions of the present invention is that they are easily capable of being applied at film thicknesses of less than 2.0 mils (50.8 microns) or less than 1.0 mil (25.4 microns) per layer. Multiple layers can be applied.

Once applied, the compositions of the present invention can be cured by radiation. Thus, for example, the compositions of the present invention may be cured by irradiation with ultraviolet rays as is known to those skilled in the art. In certain embodiments, curing can be completed in less than one minute.

In certain embodiments, an ultraviolet light source having a wavelength range of 180 to 4000 nanometers may be used to cure the compositions of the present invention. For example, sunlight, mercury lamps, arc lamps, xenon lamps, gallium lamps, and the like may be used. In one example, the compositions of the present invention may be cured by a medium pressure mercury lamp having an intensity of 48 to 360 W/cm, for a total exposure of 100 to 2000 mJ/cm², such as 500 to 1000 mJ/cm² as measured by a POWERMAP UV Radiometer commercially available from EIT Inc., Sterling, Va.

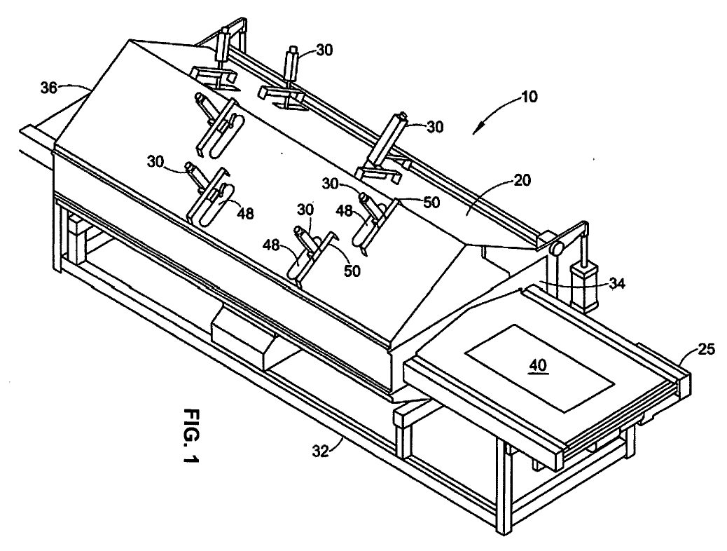

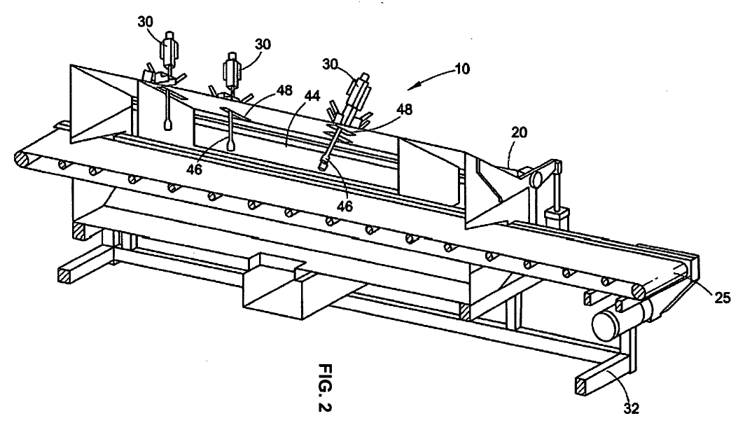

When a relatively low film thickness, i.e., less than 2.0 mils (50.8 microns) or less than 1.0 mil, is desired, the compositions of the present invention can be spray applied onto a substrate using a continuous coating apparatus, such as that disclosed in U.S. Pat. No. 6,746,535, which is incorporated herein by reference. An example of such an apparatus is also depicted in FIGS. 1 and 2.

As is apparent from FIGS. 1 and 2, a coating applicator 10 is provided that comprises a spray housing 20, a conveyer means 25 and a plurality of spray guns 30, such as high volume—low pressure (HVLP) spray guns. In the embodiment illustrated in FIG. 2, seven spray guns are provided. The spray housing 20 is mounted on a frame assembly 32 and has an entry 34 and an exit 36, through which the conveyer means 25 passes. The component to be coated 40 is placed on the conveyer means 25, which delivers the component 40 to the spray chamber 44 located within the spray housing 20. The spray guns 30 are positioned on the spray housing 20 such that the nozzle portion 46 of each of the guns 30 passes through an opening 49 in the spray housing 20 and enters the spray chamber 44. The spray guns 30 can be positioned anywhere on the spray housing 20 and pointed in any desired direction to provide the desired spray pattern.

To achieve desired film properties, such an apparatus can also control application conditions. In certain embodiments, for example, the temperature of the spray chamber 44, the temperature of the spray gun discharge stream, and/or the temperature of the substrate can be controlled between 80° up to 160° F. (270 up to 71° C.), such as 110° up to 140° F. (43° up to 60° C.). In addition, the spray guns 30 can be operated such that they form atomized particles have a mean particle diameter of 25 to 50 microns.

In one example, a mist coater of the type described above is used that includes four SATA™ HVLP spray guns (0.7 millimeter nozzles and matching aircaps) for a sealer coat in a first coating booth and four identical SATA™ HVLP spray guns for a topcoat in a second coating booth. One or both of the sealer and topcoat may be deposited from a composition of the present invention. In some examples, the spray guns are arranged as follows in each booth: (1) one side gun is arranged at 45° from horizontal, at 10 to 14 inches (25.4 to 35.6 centimeters) from the centerline of the conveyer belt; (2) one or two center guns are centered on the belt arranged at 90° from horizontal and 19 inches (48.3 centimeters) from the belt; and (3) a second side gun is arranged on the opposite side of the booth as a mirror image of the first side gun. The spray guns are operated at an atomization pressure and fan pressure of 40 psig. In some cases, the temperature of the coating is controlled at the coating source tank (100° F. (38° C.) to 180° F. (82° C.)) and the gun area (100° F. (38° C.) to 200° F. (93° C.)), the temperature of the atomization air to the spray gun is controlled (60° F. (16° C.) to 200° F. (93° C.)), the booth temperature is controlled at 70° F. (21° C.) to 150° F. (66° C.), and/or the substrate temperature is controlled at 70° F. (21° C.) to 140° F. (60° C.).

In another example, a reciprocator, such as a Cefla Easy 2000™ or Superfici Twin Spray is used in place of a mist coater using the same spray guns and flow equipment. A reciprocator uses electric eyes to locate the substrate, and then only coat those areas.

The present invention is also directed to multi-layer composite coatings. The multi-layer composite coating compositions of the present invention comprise a sealer deposited from a sealer composition and a topcoat applied over at least a portion of the sealer in which the topcoat is deposited from a topcoat composition. At least one of the sealer composition and the topcoat composition comprises a radiation curable composition of the present invention. In certain embodiments, the sealer and the topcoat compositions both comprise a radiation curable composition of the present invention.

In certain embodiments, the multi-layer composite coatings of the present invention comprise one or more underlayers, such as a stain or primer, wherein the sealer composition and the topcoat composition are applied over the underlayer(s). The underlayer(s), which may comprise a colored coating, can comprise, for example, any colored compositions useful in coatings applications, such as a composition that includes one or more pigments or dyes to act as the colorant. Such colored compositions often include a resinous binder, which may comprise, for example, one or more acrylic polymers, polyesters, such as alkyds, polyurethanes and nitrocellulose.

The multi-layer composite coatings of the present invention, wherein one, or both, of the coatings comprises a radiation curable composition of the present invention may be deposited by (a) applying to a substrate a sealer composition from which a sealer is deposited onto the substrate; (b) curing the sealer composition; (c) applying to the substrate a topcoat composition from which a topcoat is deposited over the sealer; and (d) curing the topcoat. The coating steps may, for example, be accomplished by spray coating. Moreover, the sealer coating composition may be sanded prior to coating the substrate with a topcoat composition. Furthermore, one or more underlayers may be applied to the substrate, prior to applying the sealer composition onto the substrate.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1

Coating compositions were made using the components and weight percents shown in Table 1. Coatings were prepared by mixing acrylated epoxy and about half of the modified polyether acrylate and adding under agitation dispersing additives, talc and silicas. Agitation continued until the solids were properly dispersed. Next, the remaining acrylates and the rheology additives were added under agitation. Finally, the rest of the components were added and agitation was continued for additional time to ensure complete homogenization of all components and association of the rheology modifier.

TABLE 1

| | Coat- | Coat- | Coat- | Coat- |
|---|---|---|---|---|
| | ing 1 | ing 2 | ing 3 | ing 4 |
| Acrylated epoxy¹ | 16.6 | 27.0 | 18.7 | 27.1 |
| Amine modified polyether acrylate² | 24.8 | | | |
| Amine modified polyether acrylate³ | | 11.6 | 28.1 | 11.7 |
| Anti-Terra U 80⁴ | 0.3 | | | |
| Disperbyk 182⁵ | | 0.2 | | 0.2 |
| Anti-Terra 204⁶ | | | 0.2 | |
| Talc | 5.5 | | 2.5 | |
| Silica | | 4.7 | 2.2 | 4.7 |
| 1-hydroxy cyclohexyl phenyl ketone | 2.4 | 2.5 | | |
| 2-hydroxy, 2-methyl, 1-phenyl | | | 2.3 | 2.6 |
| propane-1-one | | | | |
| (2,4,6-trimethylbenzoyl)diphenyl | 0.2 | 0.3 | | 0.3 |
| phosphine oxide | | | | |
| Bis (2,4,6-trimethylbenzoyl) phenyl | | | 0.3 | |
| phosphine oxide | | | | |
| Benzophenone | 0.5 | 0.7 | 0.5 | 0.7 |
| Byk 306⁷ | | 0.5 | 0.4 | 0.5 |
| DC 57⁸ | 1.0 | 0.9 | 0.9 | 1.8 |
| Byk 410⁹ | 0.5 | | 0.5 | |
| Ethoxylated hexanediol diacrylate | 40.0 | 34.5 | 26.2 | 33.3 |
| Dipropylene glycol diacrylate | | 10.4 | | |
| Ethoxylated trimethylolpropane | 6.8 | 5.2 | 6.6 | 5.2 |
| triacrylate | | | | |
| Isobornyl acrylate | | | 9.2 | 10.4 |
| Tinuvin 292¹⁰ | 0.5 | 0.5 | 0.5 | 0.5 |
| Tinuvin 400¹¹ | 1.0 | 1.0 | 1.0 | 1.0 |

¹Ebecryl 3212 from UCB Surface Specialties, Smyrna, GA
²Laromer PO 94F from BASF Corporation, Charlotte, NC
³Laromer PO 77F from BASF Corporation, Charlotte, NC
⁴Dispersing additive from Byk-Chemie, Wallingford, CT
⁵Dispersing additive from Byk-Chemie, Wallingford, CT
⁶Dispersing additive from Byk-Chemie, Wallingford, CT
⁷Modified poly-dimethyl-siloxane from Byk-Chemie, Wallingford, CT
⁸(Polyethylene oxide acetate-capped) siloxane from Dow Corning, Midland, MI
⁹Lower molecular weight polymeric urea from Byk-Chemie, Wallingford, CT
¹⁰Hindered amine light stabilizer from Ciba Specialty Chemicals, Tarryton, NY
¹¹UV absorber from Ciba Specialty Chemicals, Tarryton, NY

Viscosities of each of the coating compositions of Table 1 were measured at high shear at 25° C. (77° F.) using a Cone and Plate viscometer at 5000 cycles per second. Results are set forth in Table 2.

TABLE 2

| Coating | High Shear Viscosity | |
|---|---|---|
| Coating 1 | 82 | cp |
| Coating 2 | 90 | cp |
| Coating 3 | 130 | cp |
| Coating 4 | 81 | cp |

Samples of each coating composition were evaluated for weight loss at 120° F. (49° C.) using thermogravimetric analysis. Coatings 1, 2 and Coating 4 were maintained at temperature for 12 hours. Coating 3 was stopped after 30 minutes at temperature. Results are set forth in Table 3.

TABLE 3

| | Coat- | Coat- | Coat- | Coat- |
|---|---|---|---|---|
| TGA conditions | ing 1 | ing 2 | ing 3 | ing 4 |
| 120° F. (49° C.) - 30 min | <1% | 1% | 2% | <2% |
| 120° F. (49° C.) - 12 hours | 2.7% | 5.5% | | 12% |

Samples of each coating were also evaluated for weight loss after UV cure only and after UV plus bake using ASTM D5403 Method A. Coatings were applied over aluminum panels with a wire wound applicator bar to apply 10 to 15 microns (0.4 to 0.6 mils) of coating. Coatings 1 and 3 were cured by exposure to 600 mJ/cm² using 80 W/cm medium pressure mercury UV curing lamps (part no. 25-20008-E), available from Western Quartz Products, Inc. Coatings 2 and 4 were similarly cured using 800 mJ/cm². Results are set forth in Table 4.

TABLE 4

| | | % Weight Loss UV Plus |
|---|---|---|
| Coating | % Weight Loss UV Only | Bake |
| Coating 1 | 0.5% | 1.8% |
| Coating 2 | 0.5% | 3.4% |
| Coating 3 | 1.0% | 4.2% |
| Coating 4 | 2.1% | 8.0% |

### Example 2

Coating compositions were made using the components and weight percents shown in Table 5. Coatings were prepared using the procedure described in Example 1.

TABLE 5

| Description | Coating 5 | Coating 6 |
|---|---|---|
| Acrylate epoxy¹² | 16.6 | |
| Amine modified polyether acrylate² | 24.8 | 24.8 |
| SR 499¹³ | | 11.6 |
| SR 502¹⁴ | | 5.0 |
| Anti-Terra U 80⁶ | 0.3 | 0.3 |
| Talc | 5.5 | 5.5 |
| 1-hydroxy cyclohexyl phenyl ketone | 2.4 | 2.4 |
| (2,4,6-trimethylbenzoyl) diphenyl | 0.2 | 0.2 |
| phosphine oxide | | |
| Benzophenone | 0.5 | 0.5 |
| DC 57⁸ | 1.0 | 1.0 |
| Byk-410⁹ | 0.5 | 0.5 |
| ethoxylated hexanediol diacrylate | 40.0 | 40.0 |
| 3 moles ethoxylated | 6.8 | 6.8 |
| trimethylolpropane triacrylate | | |
| Tinuvin 292¹⁰ | 0.5 | 0.5 |
| Tinuvin 400¹¹ | 1.0 | 1.0 |

¹²Ebecryl 3200 from UCB Surface Specialties, Smyrna, GA
¹³Six mole ethoxylated trimethylol propane triacrylate from Sartomer, Exton, PA
¹⁴Nine mole ethoxylated trimethylol propane triacrylate from Sartomer, Exton, PA

Solventborne color layers were applied to maple wood using C1179A33 and C1265A31, as commercially available from PPG Industries, Inc., Oak Creek, Wis. C1179A33 was spray applied and dried at room temperature. C1265A31 was spray applied, excess wiped off and dried for about 15 minutes at room temperature. The colored wood was then baked for about 15 minutes at 140° F. (60° C.). Coatings 1, 5 and 6 were individually spray applied over colored wood and drawn down over Leneta black and white paper charts to apply about 10 microns (0.4 mils) of coating. Coatings were cured by exposure to 600 ml/cm² using UV equipment as described in Example 1. Coating 2 of example 1 was applied over the individual coatings to apply an additional 15 microns (0.6 mils). Coating 2 was cured by exposure to 900 mj/cm² using UV equipment as described in Example 1. Results are set forth in Table 6.

TABLE 6

| Property | Coating 1 | Coating 5 | Coating 6 |
|---|---|---|---|
| Surface Cure¹⁵ | 2 | 1 | 3 |
| Film Integrity¹⁶ | 2 | 1 | 3 |
| Intercoat adhesion¹⁷ | 1 | 2 | 1 |

¹⁵Surface cure after UV exposure in air atmosphere was evaluated by rubbing the coated surface with a paper towel and observing mar. Surface cure was ranked as 1 (least mar) best to 3 worst.
¹⁶Film integrity was evaluated by scraping the coated surface with a thumbnail. Film integrity or toughness was ranked as 1 (most resistant to deformation) to 3 worst.
¹⁷Intercoat adhesion was evaluated for the individual coatings each having coating 2 applied over them. The coated surface was scribed and adhesion was tested using ASTM D3359 and 3M 600 tape. Intercoat adhesion was defined as resistance to cohesive adhesive failure within the coated layers. Adhesion was ranked as 1 best to 3 worst.

Whereas particular embodiments of this invention have been described above for purposes of illustration, it will be evident to those skilled in the art that numerous variations of the details of the present invention may be made without departing from the invention as defined in the appended claims.

We claim:

1. A radiation curable composition comprising a mixture of:
(a) an acrylated epoxy; and
(b) at least one multi-functional acrylate,
wherein the radiation curable composition comprises a material containing an amino group, and
wherein the composition is sprayable.

2. The radiation curable composition of claim 1, wherein the radiation curable composition is substantially free of monofunctional reactive diluents and/or inert solvents.

3. The radiation curable composition of claim 1, wherein the radiation curable composition has a viscosity from 20 to 150 centipoise at high shear at 25° C.

4. The radiation curable composition of claim 1, wherein the radiation curable composition has a viscosity from 20 to 120 centipoise at high shear at 25° C.

5. The radiation curable composition of claim 1, wherein the acrylated epoxy comprises an oligomer having a viscosity of less than 10,000 centipoises at 25° C.

6. The radiation curable composition of claim 5, wherein the acrylated epoxy comprises an oligomer having a viscosity of less than 5,000 centipoises at 25° C.

7. The radiation curable composition of claim 1, wherein the acrylated epoxy comprises an oligomer having a Tg of less than 50° C.

8. The radiation curable composition of claim 7, wherein the acrylated epoxy comprises an oligomer having a Tg of less than 0° C.

9. The radiation curable composition of claim 8, wherein the acrylated epoxy comprises an oligomer having a Tg of less than −10° C.

10. The radiation curable composition of claim 1, wherein the acrylated epoxy is a multi-functional acrylated epoxy.

11. The radiation curable composition of claim 1, wherein the acrylated epoxy is present in an amount of at least 10 percent by weight based on the total weight of the radiation curable composition.

12. The radiation curable composition of claim 11, wherein the acrylated epoxy is present in an amount of 35 up to 65 percent by weight based on the total weight of the radiation curable composition.

13. The radiation curable composition of claim 11, wherein the acrylated epoxy is present in an amount of 10 up to 30 percent by weight based on the total weight of the radiation curable composition.

14. The radiation curable composition of claim 1, wherein the multi-functional acrylate has a relative molar mass of 170 to 1500 grams per mole.

15. The radiation curable composition of claim 1, wherein the multi-functional acrylate is present in an amount of less than 90 percent by weight based on the total weight of the radiation curable composition.

16. The radiation curable composition of claim 15, wherein the multi-functional acrylate is present in an amount of 35 up to 65 percent by weight based on the total weight of the radiation curable composition.

17. The radiation curable composition of claim 1, further comprising (c) a photoinitiator.

18. The radiation curable composition of claim 1, wherein the material containing an amino group comprises an amine modified (meth)acrylate.

19. The radiation curable composition of claim 18, wherein the material containing an amino group comprises an amine modified polyether acrylate.

20. The radiation curable composition of claim 18, wherein the amine modified (meth)acrylate is present in an amount of at least 5 percent by weight based on the total weight of the radiation curable composition.

21. The radiation curable composition of claim 20, wherein the amine modified (meth)acrylate acrylate is present in an amount of 10 up to 30 percent by weight based on the total weight of the radiation curable composition.

22. The radiation curable composition of claim 2, wherein the radiation curable composition comprises less than 5 percent by weight of monofunctional reactive dilients and/or inert solvents based on the total weight of the radiation curable composition.

23. The radiation curable composition of claim 22, wherein the radiation curable composition comprises less than 2 percent by weight of monofunctional reactive diluents and/or inert solvents based on the total weight of the radiation curable composition.

24. The radiation curable composition of claim 2, wherein the composition is free of monofunctional acrylate monomers.

25. The radiation curable composition of claim 1, wherein the radiation curable composition is recyclable.

26. The radiation curable composition of claim 1, wherein the radiation curable composition exhibits a weight loss as measured by thermogravimetric analysis of less than 10% at 120° F. for 12 hours.

27. The radiation curable composition of claim 26, wherein the radiation curable composition exhibits a weight loss as measured by thermogravimetric analysis of less than 7% at 120° F. for 12 hours.

28. The radiation curable composition of claim 27, wherein the radiation curable composition exhibits a weight loss as measured by thermogravimetric analysis of less than 2% at 120° F. for 12 hours.

29. The radiation curable composition of claim 1, further comprising a rheology modifier comprising a modified lower molecular weight polymeric urea.

30. The radiation curable composition of claim 1, wherein the radiation curable composition is a wood finish composition.

31. A wood finish coating composition comprising a mixture of:
(a) 10 to 30 percent by weight of an acrylated epoxy;
(b) 35 to 65 percent by weight of at least one multi-functional acrylate;
(c) 0.01 to 15 percent by weight of a photoinitiator;
(d) 10 to 30 percent by weight of an amine modified (meth)acrylate;
(e) 0.01 to 5 percent by weight of a rheology modifier;
(f) 0.01 to 10 percent by weight of a surfactant; and
(g) 0.01 to 10 percent by weight of a UV-light stabilizer,
wherein the percents by weight are based on the total weight of the composition, and
wherein the wood finish coating composition is sprayable.

32. The wood finish coating composition of claim 30, wherein the composition is substantially free of monofunctional reactive diluents and/or inert solvents.

33. The wood finish coating composition of claim 30, wherein the composition has a viscosity from 20 to 150 centipoise at high shear at 25° C.

34. The wood finish composition of claim 33, wherein the composition has a viscosity from 20 to 120 centipoise at high shear at 25° C.

35. The wood finish composition of claim 31, wherein the acrylated epoxy comprises an oligomer having a viscosity of less than 10,000 centipoises at 25° C.

36. The wood finish composition of claim 35, wherein the acrylated epoxy comprises an oligomer having a viscosity of less than 5,000 centipoises at 25° C.

37. The wood finish composition of claim 31, wherein the acrylated epoxy comprises an oligomer having a Tg of less than 50° C.

38. The wood finish composition of claim 37, wherein the acrylated epoxy comprises an oligomer having a Tg of less than 0° C.

39. The wood finish composition of claim 38, wherein the acrylated epoxy comprises an oligomer having a Tg of less than −10C.

40. The wood finish composition of claim 31, wherein the acrylated epoxy is a multi-functional acrylated epoxy.

41. The wood finish composition of claim 31, wherein the multi-functional acrylate has a relative molar mass of 170 to 1500 grams per mole.

42. The wood finish composition of claim 31, wherein the amine modified (meth)acrylate comprises an amine modified polyether acrylate.

43. The wood finish composition of claim 32, wherein the wood finish composition comprises less than 5 percent by weight of monofunctional reactive diluents and/or inert solvents based on the total weight of the wood finish composition.

44. The wood finish composition of claim 43, wherein the wood finish composition comprises less than 2 percent by weight of monofunctional reactive diluents and/or inert solvents based on the total weight of the wood finish composition.

45. The wood finish composition of claim 32, wherein the composition is free of monofunctional acrylate monomers.

46. The wood finish composition of claim 31, wherein the wood finish composition is recyclable.

47. The wood finish composition of claim 31, wherein the wood finish composition exhibits a weight loss as measured by thermogravimetric analysis of less than 10% at 120° F. for 12 hours.

48. The wood finish composition of claim 47, wherein the wood finish composition exhibits a weight loss as measured by thermogravimetric analysis of less than 7% at 120° F. for 12 hours.

49. The wood finish composition of claim 48, wherein the wood finish composition exhibits a weight loss as measured by thermogravimetric analysis of less than 2% at 120° F. for 12 hours.

50. The wood finish of claim 31, wherein the rheology modifier comprises a modified lower molecular weight polymeric urea.

51. A multi-layer composite coating comprising a sealer deposited from a sealer composition and a topcoat applied over at least a portion of the sealer in which the topcoat is deposited from a topcoat composition, wherein at least one of the sealer composition and the topcoat composition comprises the radiation curable composition of claim 1.

52. The multi-layer composite coating of claim 51, further comprising at least one underlayer deposited from an underlayer composition over which the sealer composition is applied.

53. The multi-layer composite coating of claim 50, wherein both of the sealer composition and the topcoat composition comprises the radiation curable composition of claim 1.

54. The multi-layer composite coating of claim 51, wherein the radiation curable composition is substantially free of monofunctional reactive diluents and/or inert solvents.

55. The multi-layer composite coating of claim 51, wherein the radiation curable composition has a viscosity from 20 to 150 centipoise at high shear at 25° C.

56. The multi-layer composite coating of claim 55, wherein the radiation curable composition has a viscosity from 20 to 120 centipoise at high shear at 25° C.

57. The multi-layer composite coating of claim 51, wherein the acrylated epoxy comprises an oligomer having a viscosity of less than 10,000 centipoise at 25° C.

58. The multi-layer composite coating of claim 51, wherein the acrylated epoxy comprises an oligomer having a Tg of less than 50° C.

59. The multi-layer composite coating of claim 58, wherein the acrylated epoxy comprises an oligomer having a Tg of less than −10° C.

60. The multi-layer composite coating of claim 51, wherein the material containing an amino group comprises an amine modified (meth)acrylate.

61. The multi-layer composite coating of claim 54, wherein the radiation curable composition comprises less than 5 percent by weight of monofunctional reactive diluents and/or inert solvents based on the total weight of the radiation curable composition.

62. The multi-layer composite coating of claim 61, wherein the radiation curable composition comprises less than 2 percent by weight of monofunctional reactive diluents and/or inert solvents based on the total weight of the radiation curable composition.

63. The multi-layer composite coating of claim 54, wherein the composition is free of monofunctional acrylate monomers.

64. The multi-layer composite coating of claim 51, wherein the radiation curable composition is recyclable.

65. The multi-layer composite coating of claim 51, wherein the radiation curable composition exhibits a weight loss as measured by thermogravimetric analysis of less than 10% at 120° F. for 12 hours.

66. The multi-layer composite coating of claim 65, wherein the radiation curable composition exhibits a weight loss as measured by thermogravimetric analysis of less than 7% at 120° F. for 12 hours.

67. The multi-layer composite coating of claim 66, wherein the radiation curable composition exhibits a weight loss as measured by thermogravimetric analysis of less than 2% at 120° F. for 12 hours.

68. The multi-layer composite coating of claim 51, wherein the radiation curable composition comprises:
(a) 10 to 30 percent by weight of an acrylated epoxy;
(b) 35 to 65 percent by weight of at least one multi-functional acrylate;
(c) 0.01 to 15 percent by weight of a photoinitiator;
(d) 10 to 30 percent by weight of an amine modified (meth)acrylate;
(e) 0.01 to 5 percent by weight of a rheology modifier;
(f) 0.01 to 10 percent by weight of a surfactant; and
(g) 0.01 to 10 percent by weight of a UV-light stabilizer,
wherein the percents by weight are based on the total weight of the composition.
